(19) United States
(12) Patent Application Publication
(10) Pub. No.: US 2010/0150568 A1
(43) Pub. Date: Jun. 17, 2010

(54) OPTICAL TRANSCEIVER OPTIMIZING TRANSFER CHARACTERISTIC OF OPTICAL INTERFEROMETER AND METHOD OF OPTIMIZING TRANSFER CHARACTERISTIC OF OPTICAL INTERFEROMETER OF OPTICAL TRANSCEIVER

(76) Inventors: Joon Ki Lee, Daejeon-si (KR); Hwan Seok Chung, Daejeon-si (KR); Sae Kyoung Kang, Daejeon-si (KR); Jyung Chan Lee, Daejeon-si (KR); Kwangjoon Kim, Daejeon-si (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/538,024

(22) Filed: Aug. 7, 2009

(30) Foreign Application Priority Data
Dec. 16, 2008 (KR) 10-2008-0127961

(51) Int. Cl. H04B 10/00

(52) U.S. Cl. 398/137

(57) ABSTRACT

An optical transceiver for optimizing transfer characteristic of an optical interferometer and a method of optimizing transfer characteristic of an optical interferometer of an optical transceiver are provided. It is possible to improve the transmission performance of the optical transceiver by optimizing the transfer characteristic of the optical interferometer included in an optical receiver of the optical transceiver which transmits and receives an optical signal in a phase modulation scheme.

### CROSS-REFERENCE TO RELATED APPLICATION

This application claims the benefit under 35 U.S.C. §119(a) of Korean Patent Application No. 10-2008-0127961, filed on Dec. 16, 2008, the disclosure of which is incorporated by reference in its entirety for all purposes.

### BACKGROUND

1. Field

The following description relates to optimized transfer characteristic of an optical interferometer and, more particularly, to an optical transceiver for optimizing transfer characteristic of an optical interferometer and a method of optimizing transfer characteristic of is an optical interferometer in the optical transceiver.

2. Description of the Related Art

An optical differential phase-shift keying (DPSK) or differential quadrature phase-shift keying (DQPSK) transceiver, which is a modulation scheme that conveys information by modulating the phase of an optical signal, requires an optical interferometer, which converts a phase-modulated optical signal into an intensity-modulated optical signal, in a previous stage of an optical detector.

Since the transfer characteristic of such an optical interferometer depends on input wavelength, the optical transceiver having wavelength tunable function needs to optimize the transfer characteristic of the optical interferometer according to the wavelength.

FIG. 1 is a block diagram of a conventional phase modulated optical transceiver. The optical transceiver 100 includes an optical transmitter 110 and an optical receiver 120.

The optical transmitter 110 includes a laser diode (LD) 111, a phase modulator 112, a pre-coder 113, and an amplifier 114. The optical receiver 120 includes an optical interferometer 121, an optical to electrical (O-E) converter 122, a differential amplifier 123, and a clock data recovery 124.

The laser diode 111 generates an optical signal. The phase modulator 112 modulates the phase of the optical signal from the laser diode 111. For example, a Mach-Zehnder (MZ) modulator may modulate an optical signal to have a phase of 0 or π.

The pre-coder 113 performs a pre-coding operation at the transmitter so that input data of an optical interferometer at the receiver becomes equal to output data at the transmitter.

The amplifier 114 amplifies the pre-coded signal and outputs it to the phase modulator 112. The optical transmitter 110 outputs the phase-modulated optical signal to the optical receiver 120.

The optical interferometer 121 converts the phase-modulated optical signal into an intensity-modulated optical signal. The O-E converter 122 converts the intensity-modulated optical signal into an electrical signal.

The differential amplifier 123 amplifies the electrical signal by the differential gain. The clock data recovery 124 recovers original data from the amplified electrical signal which was transmitted by the transmitter.

The optical interferometer 121 combines a previous bit and a current bit in such a way that interference occurs between them to convert the phase-modulated signal into the intensity-modulated signal. The optical interferometer 121 includes two output ports—a constructive port, a destructive port. In case of the constructive port, a maximum optical intensity (i.e., “1”) is output if there is no difference in phase between a previous bit and a current bit, and a minimum optical intensity (i.e., “0”) is output if a different in phase between them is π. The destructive port is opposed to the constructive port.

As shown in FIG. 2, the transfer characteristic of the optical interferometer 121 is periodic with respect to the wavelength and is sensitive to a change in temperature. Hence, the optical interferometer 121 needs to be controlled under a constant temperature to obtain the maximum transmittance at a certain wavelength.

As shown in FIG. 3, if the laser diode 111 drifts from λ1 to λ2 in wavelength due to an environmental change, the transmittance is reduced and the receiver sensitivity of the opto-electrical converter 122 becomes poor. Hence, the transmittance of the optical interferometer needs to be controlled to be optimal.

### SUMMARY

The following description relates to an optical transceiver capable of optimizing transfer characteristic of an optical interferometer included in an optical receiver of the optical transceiver transmitting and receiving an optical signal in a phase modulation scheme, and a method of optimizing the transfer characteristic of the optical interferometer of the optical transceiver.

In one general aspect, the optical transceiver searches for control voltage which corresponds to a receiving optical channel from the control voltage of each channel stored beforehand and outputs control voltage corresponding to the found receiving channel to the optical interferometer, so that the transfer characteristic of the optical interferometer may be optimized.

In another general aspect, the optical transceiver searches for a range of control voltages in which no error occurs while varying control voltage output to the optical interferometer, and selects and outputs control voltage within the found range of control voltages to the optical interferometer, so that the transfer characteristic of the optical interferometer may be optimized.

Accordingly, it is possible to optimize the transfer characteristic of the optical interferometer included in the optical receiver of the optical transceiver which transmits and receives an optical signal in a phase modulation scheme and thus to improve the transmission performance of the optical transceiver.

However, other features and aspects will be apparent from the following description, the drawings, and the claims.

### BRIEF DESCRIPTION OF THE DRAWINGS

FIG. 1 is a block diagram of a conventional phase modulated optical transceiver.

FIG. 2 illustrates change in transmittance of an optical interferometer according to change in wavelength.

FIG. 3 illustrates how to adjust a maximum transmittance point of an optical interferometer according to change in wavelength.

FIG. 4 illustrates change in transmittance according to change in transmission wavelength.

FIG. 5 illustrates how to adjust a maximum transmittance point of an optical interferometer according to change in transmission wavelength.

FIG. 6 is a block diagram of an optical transceiver having an optimized transfer characteristic of an optical interferometer according to an exemplary embodiment of the present invention.

FIG. 7 is a block diagram of an optical transceiver having an optimized transfer characteristic of an optical interferometer according to another exemplary embodiment of the present invention.

FIG. 8 is a block diagram of an optical transceiver having an optimized transfer characteristic of an optical interferometer according to another exemplary embodiment of the present invention.

FIG. 9 illustrates a case where a maximum transmittance matches with an ITU-T grid.

FIG. 10 is a flow chart of a method of optimizing transfer characteristic of an optical interferometer in an optical transceiver according to an exemplary embodiment of the present invention.

FIG. 11 is a flow chart of a method of optimizing transfer characteristic of an optical interferometer in an optical transceiver according to another exemplary embodiment of the present invention.

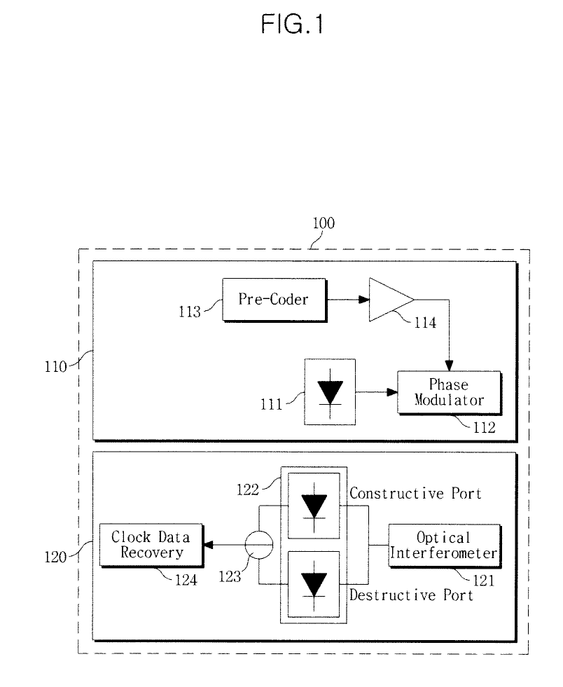

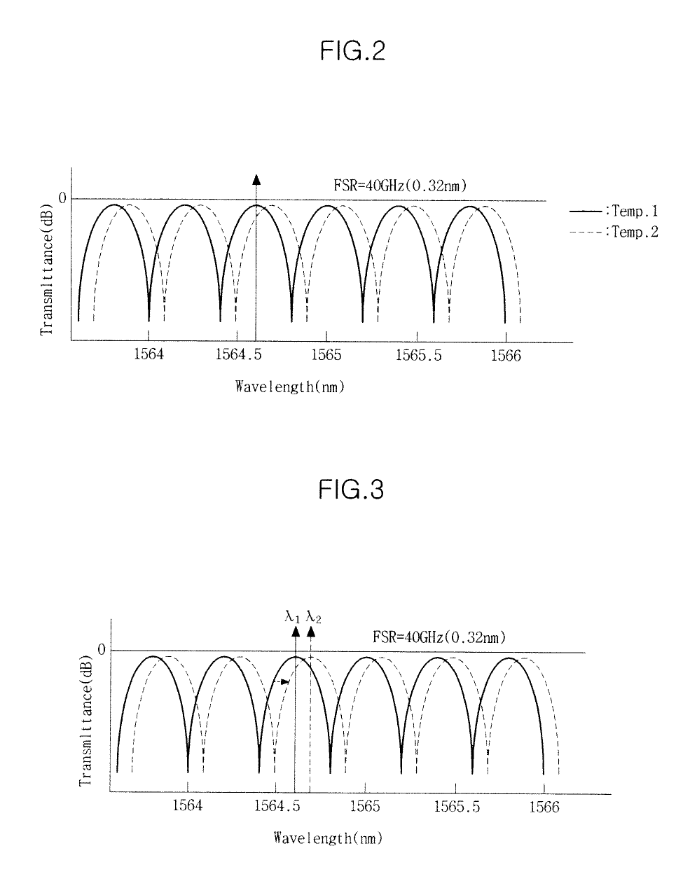

Throughout the drawings and the detailed description, unless otherwise described, the same drawing reference numbers refer to the same elements, features, and structures. The relative size and depiction of these elements may be exaggerated for clarity, illustration, and convenience.

### DETAILED DESCRIPTION

The detailed description is provided to assist the reader in gaining a comprehensive understanding of the methods, apparatuses and/or systems described herein. Accordingly, various changes, modifications, and equivalents of the systems, apparatuses, and/or methods described herein will be suggested to those of ordinary skill in the art. Also, descriptions of well-known functions and constructions are omitted to increase clarity and conciseness.

Throughout the specification, the term optical transceiver refers to a device employing a phase modulation scheme including differential phase-shift keying (DPSK) and differential quadrature phase-shift keying (DQPSK), which conveys information by modulating the phase of an optical signal. The optical transceiver may be applied to dense wavelength division multiplexing (DWDM) and reconfigurable optical add-drop multiplexing (ROADM) systems which are employed in metro or backbone networks.

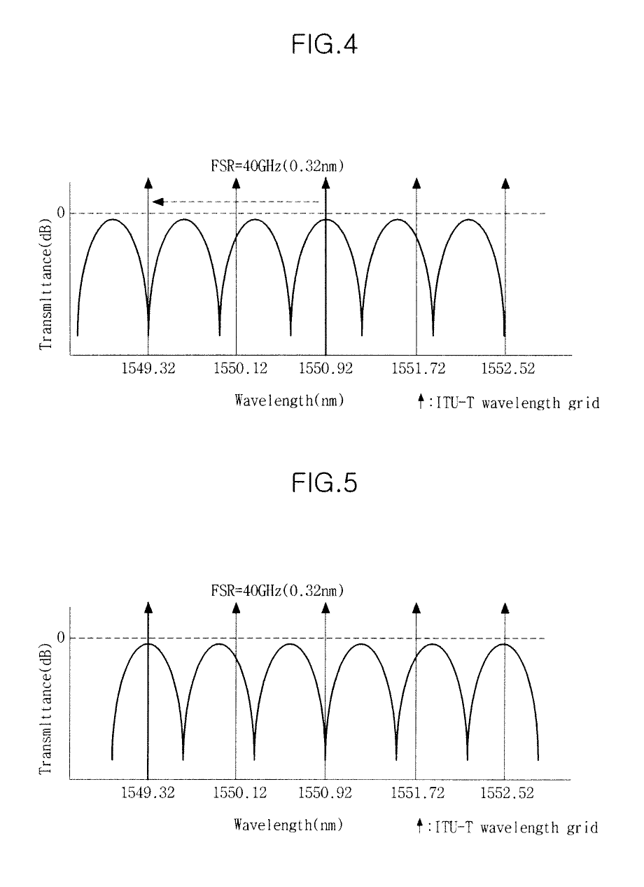

FIGS. 4 and 5 illustrate transmittance graphs of an optical interferometer at 40 Gb/s with ITU-T (International Telecommunication Union—Telecommunication Standardization Sector) grid and 25 ps delay (one bit delay).

Referring to FIG. 4, a thick arrow indicates a DWDM channel wavelength which is defined in ITU-T, and a wavelength period of an optical interferometer with 25 ps delay is 0.32 nm. If a wavelength of 1550.92 nm is used at the transmitter, an optical interferometer at the receiver needs to be controlled to have a maximum transmittance at a wavelength of 1550.92 nm.

If the wavelength is changed to 1549.32 nm at the transmitter, the optical interferometer has the lowest transmittance as shown in FIG. 5. As a result, the transfer characteristic of the optical interferometer needs to be controlled to have the maximum transmittance at a wavelength of 1549.32 nm. A method of optimizing the transfer characteristic of the optical interferometer will now be described.

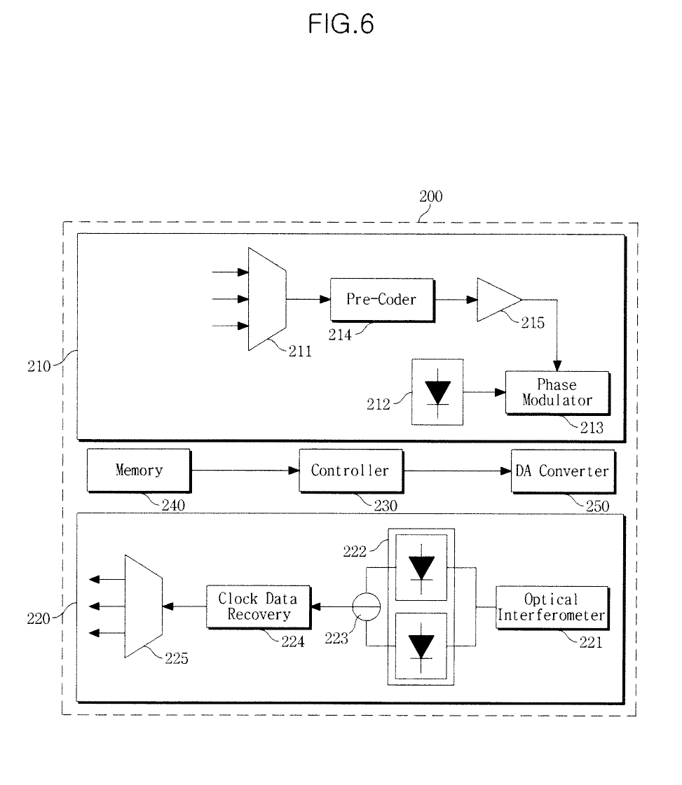

FIG. 6 is a block diagram of an optical transceiver having an optimized transfer characteristic of an optical interferometer according to an exemplary embodiment of the present invention. The optical transceiver 200 includes an optical transmitter 210, an optical receiver 220, and a controller 230.

The optical transmitter 210 includes a multiplexer (MUX) 211, a laser diode (LD) 212, a phase modulator 213, a pre-coder 214, and an amplifier 215.

The multiplexer 211 multiplexes n A Gb/s signals into a B Gb/s signal.

The laser diode 212 generates an optical signal. The phase modulator 213 modulates the phase of the optical signal. For example, if a Mach-Zehnder (MZ) modulator is used as the phase modulator 213, an optical signal is phase-modulated to 0 or π.

The pre-coder 214 encodes a signal multiplexed by the multiplexer 211 at the transmitter so that input data of the optical interferometer at the receiver becomes equal to output data of the optical interferometer at the transmitter.

The amplifier 215 amplifies the pre-coded signal and outputs it to the phase modulator 213. The phase-modulated optical signal from the optical transmitter 210 is received by the optical receiver 220.

The optical receiver 220 includes an optical interferometer 221, an O-E converter 222, a differential amplifier 223, a clock data recovery 224, and a demultiplexer (DMUX) 225.

The optical interferometer 221 converts a phase-modulated signal into an intensity-modulated signal. The O-E converter 222 converts the intensity-modulated signal into an electrical signal.

The differential amplifier 223 amplifies the electrical signal by the differential gain. The clock data recovery 224 recovers original data, which was transmitted by the transmitter, from the amplified electrical signal.

The demultiplexer 225 demultiplexes the recovered data.

The controller 230 controls to optimize the transfer characteristic of the optical interferometer. Unlike the conventional optical interferometer of which transmittance is significantly dependent on temperature, a recent optical interferometer is nearly independent on the temperature and easily adjusts a central wavelength by means of voltage regulation. Hence, the optical interferometer don't needs to be optimized with respect to change in temperature and needs only to prepare for change in channel of the wavelength by use of the controller 230.

For this, the controller 230 may output control voltage for optimizing transmittance of the optical interferometer 221 to the optical interferometer 221 so that the optical interferometer 221 may have an optimized transfer characteristic.

Accordingly, the optical transceiver 200 may select and output the control voltage for optimizing the transmittance of the optical interferometer 221 by means of the controller 230 so that the optical interferometer 221 may have an optimized transfer characteristic. As a result, it is possible to improve the transmission performance quickly and accurately.

In one embodiment, the optical transceiver 200 may further include a memory 240. The memory 240 stores control voltage for each of receiving channels where the optical interferometer 221 has a maximum transmittance.

According to this embodiment, by determining control voltage for each receiving channel to maximize the transmittance of the optical interferometer and storing in advance the control voltage in the memory 240, the controller 230 may use the stored control voltage and control the transfer characteristic of the optical interferometer in an optimum condition.

The controller 230 searches for control voltage which corresponds to a receiving optical channel from the control voltage of each channel stored beforehand and outputs control voltage corresponding to the found receiving channel to the optical interferometer 221, so that the transfer characteristic of the optical interferometer 221 may be optimized. As a result, it is possible to improve the transmission performance.

In one embodiment, the optical transceiver 200 may further include a DA converter 250. The DA converter 250 converts a digital control voltage from the controller 230 into an analog control voltage.

According to this embodiment, when the controller 230 searches for the control voltage, which corresponds to a receiving optical channel from the control voltage of each channel stored in the memory 240 and outputs the found control voltage for the receiving channel to the optical interferometer 221, the DA converter converts the control voltage into an analog control voltage.

Accordingly, the optical interferometer 221 has an optimized transfer characteristic. As a result, it is possible to improve the transmission performance.

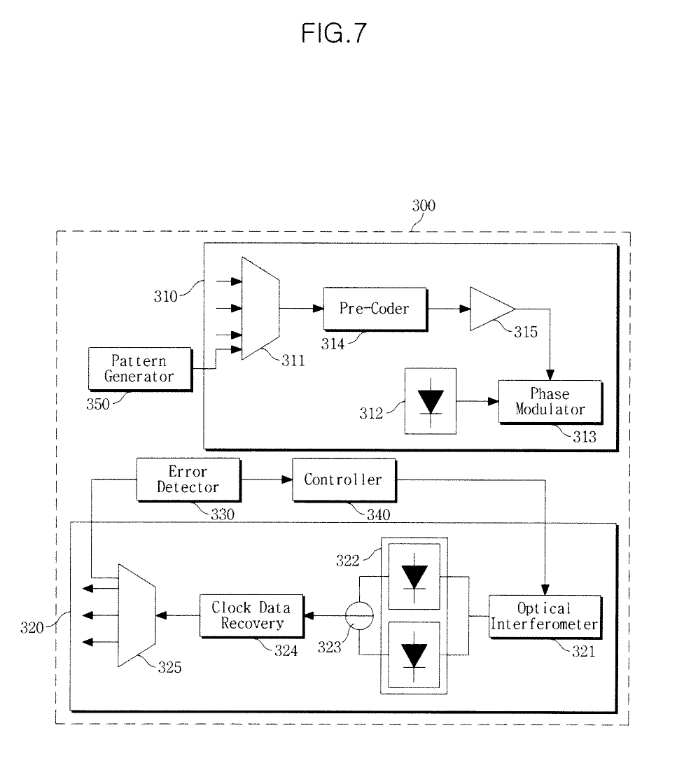

FIG. 7 is a block diagram of an optical transceiver according to another exemplary embodiment of the present invention. The optical transceiver 300 includes an optical transmitter 310, an optical receiver 320, an error detector 330, and a controller 340.

The optical transmitter 310 includes a multiplexer (MUX) 311, a laser diode 312, a phase modulator 313, a pre-coder 314, and an amplifier 315.

The multiplexer 311 multiplexes n A Gb/s signals into a B Gb/s signal.

The laser diode 312 generates an optical signal. The phase modulator 313 modulates the phase of the optical signal. For example, a Mach-Zehnder modulator used as the phase modulator 313 modulates the phase of an optical signal to 0 or π.

The pre-coder 314 encodes a signal multiplexed by the multiplexer 311 at the transmitter so that input data of the optical interferometer at the receiver becomes equal to output data of the optical interferometer at the transmitter.

The amplifier 315 amplifies the pre-coded signal and outputs it to the phase modulator 313. The phase-modulated optical signal from the optical transmitter 310 is received by the optical receiver 320.

The optical receiver 320 includes an optical interferometer 321, an O-E converter 322, a differential amplifier 323, a clock data recovery 324, and a demultiplexer (DMUX) 325.

The optical interferometer 321 converts a phase-modulated signal into an intensity-modulated signal. The opto-electrical converter 322 converts the intensity-modulated signal into an electrical signal.

The differential amplifier 323 amplifies the electrical signal by the differential gain. The clock data recovery 324 recovers original data from the amplified electrical signal which has been transmitted by the transmitter.

The demultiplexer 325 demultiplexes the recovered data.

The error detector 330 monitors an error occurrence from an optical signal fed back from the optical receiver 320.

The controller 340 controls to optimize the transfer characteristic of the optical interferometer by selecting an appropriate control voltage for the optical interferometer according to the error occurrence detected by the error detector 330 and outputting the selected control voltage to the optical interferometer 321.

The controller 340 may be configured to search a range of control voltages in which no error occurs using the error detector 330 while changing the control voltage output to the optical interferometer 321, and select and output control voltage within the found range of control voltages to the optical interferometer 321 so that the transfer characteristic of the optical interferometer may be optimized.

For example, the controller 340 may output to the optical interferometer a mean value of the range of control voltages in which no error occurs so that the transfer characteristic of the optical interferometer may be optimized.

Accordingly, the optical transceiver 300 searches a range of control voltages in which no error occurs using the error detector 330, selects control voltage within the found range of control voltages to optimize the transmittance of the optical interferometer 321, and outputs the selected control voltage to the optical interferometer 321. As a result, it is possible to optimize the transfer characteristic of the optical interferometer 321 quickly and accurately and thus to improve the transmission performance.

In one embodiment, the error detector 330 may be configured to detect an error from an optical signal using an error check signal pattern included in the optical signal.

In this case, the optical transceiver 300 may further include a signal pattern generator 350. The signal patter generator 350 generates an error check signal pattern included in a phase-modulated optical signal which the optical transmitter 310 outputs to a network.

For example, the error check signal pattern may be a pseudo random bit sequence (PRBS) pattern. If the optical transceiver 300 starts operating or has to change a wavelength, a PRBS pattern is generated by the pattern generator 350 and is multiplexed by the multiplexer 311 together with an optical signal. The multiplexed PRBS pattern is then transmitted to the receiver.

The error detector 330 detects from the PRBS pattern that the optical transceiver 300 starts operating or has to change a wavelength, and the controller 340 selects and outputs control voltage for optimum transmittance accordingly. As a result, it is possible to optimize the transfer characteristic of the optical interferometer 321 quickly and accurately and thus to improve the transmission performance.

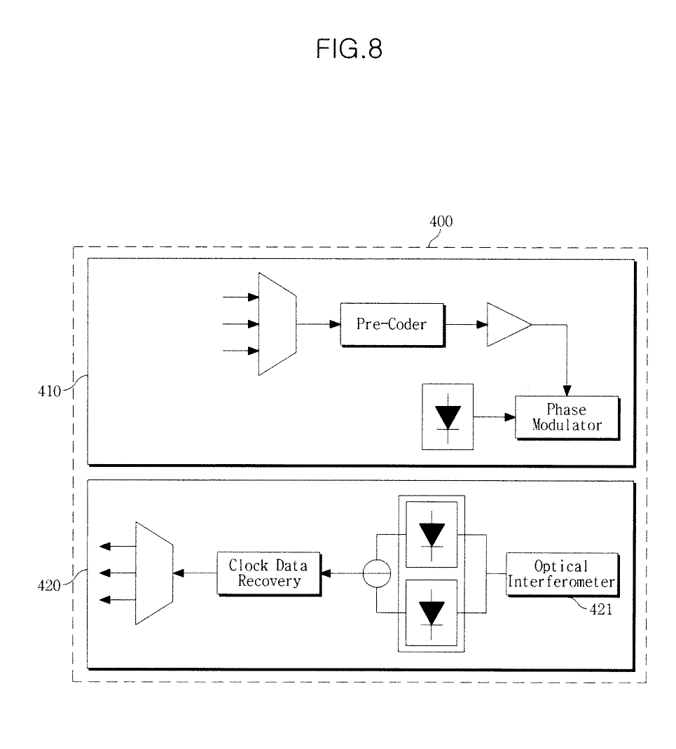

FIG. 8 is a block diagram of an optical transceiver according to another embodiment of the present invention. The optical transceiver 400 includes an optical transmitter 410 and an optical receiver 420.

The optical transmitter 410 and the optical receiver 420 are identical to the optical transmitter 210 and 310 and the optical receiver 220 and 320 shown in FIGS. 6 and 7 and a detailed description thereof will thus be omitted herein.

The optical transceiver 400 employs an optical interferometer of which transmittance matches with an absolute wavelength of ITU-T (International Telecommunication Union—Telecommunication Standardization Sector) grid.

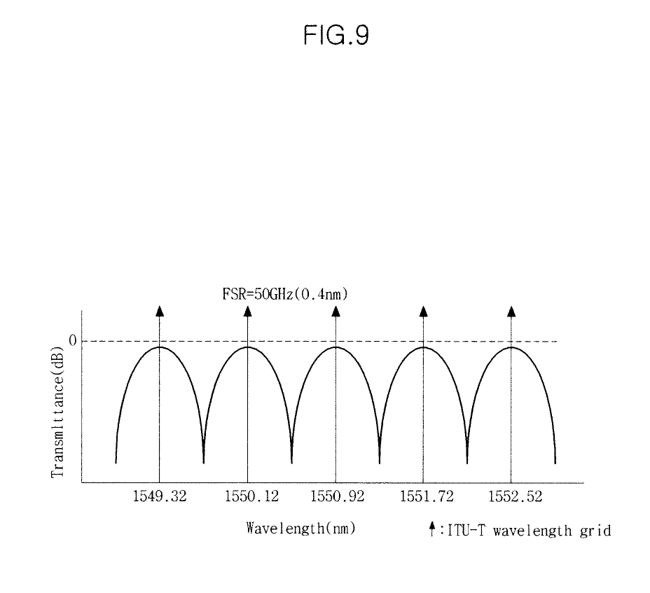

FIG. 9 is a graph illustrating the situation when free spectral range (FSR) is 50 GHz (0.4 nm) and a maximum transmittance matches with an ITU-T wavelength grid. In this case, since an optimum transmittance is obtained irrespective of varying wavelength, no controller is necessary. If FSR is 50 GHz, no one (1) bit delay occurs with respect to an optical signal of 40 Gb/s, which may cause some penalty to the reception sensitivity.

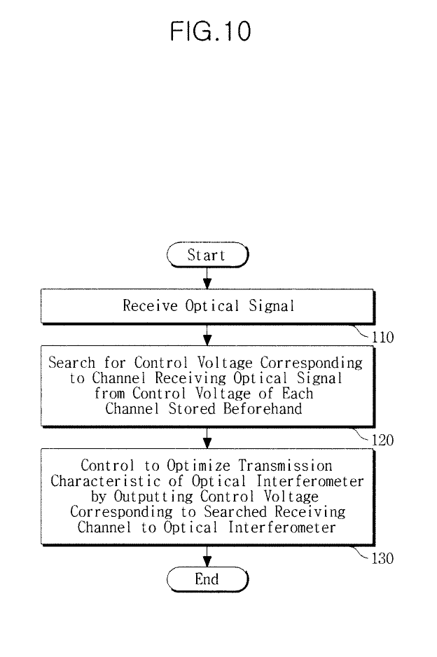

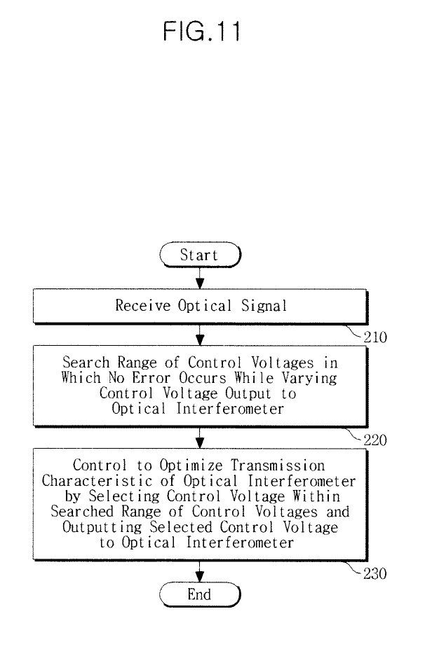

FIG. 10 is a flow chart of a method of optimizing transfer characteristic of an optical interferometer of an optical transceiver according to an exemplary embodiment of the present invention. FIG. 11 is a flow chart of a method of optimizing transfer characteristic of an optical interferometer of an optical transceiver according to another exemplary embodiment of the present invention.

Referring to FIG. 10, in operation 110, the optical transceiver receives an optical signal.

In operation 120, the optical transceiver searches control voltage, which corresponds to a channel receiving an optical signal from the control voltage of each channel stored beforehand.

In operation 130, the optical transceiver outputs control voltage corresponding to the found channel to an optical interferometer to optimize the transfer characteristic of the optical interferometer.

At this time, the optical transceiver may convert digital control voltage into analog control voltage and output the analog control voltage to the optical interferometer.

Accordingly, it is possible to optimize the transfer characteristic of the optical interferometer quickly and accurately and thus to improve the transmission performance.

Referring to FIG. 11, in operation 210, the optical transceiver receives an optical signal.

In operation 220, the optical transceiver changes control voltage output to an optical interferometer to search for a range of control voltages in which no error occurs.

In operation 230, the optical transceiver selects and outputs control voltage in the found range of control voltages to an optical interferometer to optimize the transfer characteristic of the optical interferometer.

At this time, the optical transceiver may output a mean value of the range of control voltages to the optical interferometer.

The optical signal may include an error check signal pattern. In this case, in operation 230, the optical transceiver may use the error check signal pattern included in the optical signal to search for a range of control voltages in which no error occurs.

Accordingly, it is possible to optimize the transfer characteristic of the optical interferometer quickly and accurately and thus to improve the transmission performance.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An optical transceiver for optimizing transfer characteristic of an optical interferometer, comprising:
an optical transmitter to output a phase-modulated optical signal to a network;
an optical receiver to receive the phase-modulated optical signal from the network and comprise the optical interferometer which converts the phase-modulated optical signal into an intensity-modulated optical signal; and
a controller to control to optimize the transfer characteristic of the optical interferometer.

2. The optical transceiver of claim 1, wherein the controller outputs control voltage for optimizing transmittance of the optical interferometer to a corresponding optical interferometer to optimize transfer characteristic of the optical interferometer.

3. The optical transceiver of claim 2, further comprising a memory to store control voltage for each of receiving channels where the control voltage is that the transmittance of the optical interferometer is maximized.

4. The optical transceiver of claim 3, wherein the controller searches for control voltage which corresponds to a channel receiving an optical signal from the control voltage of each channel stored beforehand, and outputs the found control voltage corresponding to the receiving channel to the optical interferometer.

5. The optical transceiver of claim 4, further comprising a DA converter to convert digital control voltage output from the controller into analog control voltage.

6. An optical transceiver for optimizing transfer characteristic of an optical interferometer, comprising:
an optical transmitter to output a phase-modulated optical signal to a network;
an optical receiver to receive the phase-modulated optical signal from the network and comprise the optical interferometer which converts the phase-modulated optical signal into an intensity-modulated optical signal;
an error detector to monitor an error occurrence from an optical signal fed back from a last stage of the optical receiver; and
a controller to control to optimize the transfer characteristic of the optical interferometer by selecting control voltage for the optical interferometer according to the error occurrence and outputting the selected control voltage to the optical interferometer.

7. The optical transceiver of claim 6, wherein the controller searches for a range of control voltages in which no error occurs using the error detector while varying control voltage output to the optical interferometer, selects control voltage within the found range of control voltages and outputs the selected control voltage to a corresponding optical interferometer to optimize transfer characteristic of the optical interferometer.

8. The optical transceiver of claim 7, wherein the controller outputs a mean value of the range of control values to the optical interferometer.

9. The optical transceiver of claim 6, wherein the error detector detects an error occurrence from an optical signal using an error check signal pattern included in the optical signal.

10. The optical transceiver of claim 9, further comprising a signal pattern generator to generate an error check signal pattern included in the phase-modulated optical signal.

11. An optical transceiver for optimizing transfer characteristic of an optical interferometer, comprising:
an optical transmitter to output a phase-modulated optical signal to a network; and
an optical receiver to receive the phase-modulated optical signal from the network and comprise an optical interferometer of which transmittance matches with an absolute wavelength of ITU-T (International Telecommunication Union—Telecommunication Standardization Sector Grid).

12. A method of optimizing transfer characteristic of an optical interferometer of an optical transceiver, the method comprising:
receiving an optical signal;
searching control voltage which corresponds to a channel receiving the optical signal from the control voltage of each channel stored beforehand; and
controlling to optimize the transfer characteristic of the optical interferometer by outputting the found control voltage corresponding to the found receiving channel to the optical interferometer.

13. The method of claim 12, wherein controlling comprises converting digital control voltage corresponding to the found receiving channel into analog control voltage.

14. A method of optimizing transfer characteristic of an optical interferometer of an optical transceiver, the method comprising:
receiving an optical signal;
searching a range of control voltages in which no error occurs while varying control voltage output to the optical interferometer; and
controlling to optimize the transfer characteristic of the optical interferometer by selecting control voltage within the found range of control voltages and outputting the selected control voltage to the optical interferometer.

15. The method of claim 14, wherein controlling comprises outputting to the optical interferometer a mean value of the range of control voltages in which no error occurs.

16. The method of claim 14, wherein the optical signal comprises an error check signal pattern.

17. The method of claim 16, wherein searching comprises searching the range of control voltages in which no error occurs from the optical signal using an error check signal pattern included in the optical signal.
